(19) United States
(12) Patent Application Publication
(10) Pub. No.: US 2010/0247234 A1
(43) Pub. Date: Sep. 30, 2010

(54) System for Precisely Adjusting the Space Between Two Elements

(75) Inventor: Martin Closs, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Astrium GmbH, Taufkirchen (DE)

(21) Appl. No.: 12/732,679

(22) Filed: Mar. 26, 2010

(30) Foreign Application Priority Data
Mar. 27, 2009 (DE) 102009014718.7-41

(51) Int. Cl. F16D 1/00

(52) U.S. Cl. 403/299

(57) ABSTRACT

A device for precisely adjusting the space between two elements includes a connection member that mutually connects the first element and the second element, a first space adjusting member, and a second space adjusting member. The first space adjusting member has a first thread that interacts with an assigned counterthread of one of the elements, and the second space adjusting member has a second thread that interacts with an assigned counterthread of the first space adjusting member or of the other of the elements. The first thread and the second thread have different thread pitches.

This application claims the priority of German patent document 10 2009 014 718.7, filed Mar. 27, 2009, the disclosure of which is expressly incorporated by reference herein.

The present invention relates to an apparatus for the highly stressable precision adjustment of the space between two elements.

### BACKGROUND OF THE INVENTION

Devices of this type provide precisely adjustable connections of components which must be positioned stably, and with high precision, relative to one another. Frequently, such connections must be suitable for high initial stress and, in particular, must meet high cleanness demands, especially in aerospace technology. So far, ground-to-size so-called “shims” have been used for producing such highly precise and stable finely adjustable connections. The manufacture of such shims, however, represents a high-expenditure process that lasts one to five days. Prior to that, the exact desired measurements have to be determined for the shims to be produced and a corresponding technical drawing has to be prepared. After production of the shims, they must be cleaned (a high-expenditure process) in order to achieve the high degree of cleanness required, for example, for aerospace technology.

Particularly when the precision adjustment of the space between the two elements must take place iteratively, it may be required that the process of producing fitting shims be carried out several times, which drastically increases the manufacturing time.

Adjusting screws with fine-pitch threads or differential threads are known and commercially available, and are frequently used in the optical field. However, because of the fine construction provided for optical applications, these commercially available adjusting screws are not suitable for absorbing high loads and high initial stress as they occur in aerospace technology.

Adjusting screws suitable for higher loads are also known, but do not permit an adjustment of the same fineness as the present invention because they have no differential thread.

### SUMMARY OF THE INVENTION

It is therefore an object of the present invention to provide an apparatus for precision adjustment of the space between two elements, which is suitable for high initial stress, meets high cleanness demands and permits rapid and problem-free precision adjustment of the space.

This and other objects and advantages are achieved by the precision adjustment coupling according to the invention, which has a connection member that mutually connects the first and the second element, as well as a first space adjusting member and a second space adjusting member. The first space adjusting member is provided with a first thread, which interacts with an assigned counterthread of one of the elements. The second space adjusting member is provided with a second thread which interacts with an assigned counterthread either of the first space adjusting member or of the other of the elements. The first thread and the second thread have different thread pitches.

The provision of two different threads with different thread pitches makes it possible to guarantee a finer adjusting capability by fixing the first space adjusting member and rotating only the second member: With each rotation of the second member, the two elements move only by the difference between the thread pitches in the two members. It thereby becomes possible to use relatively coarse-pitch threads which withstand high loads, without giving up the capacity for precise adjustment.

The counterthread assigned to the second thread of the second space adjusting member is preferably provided on or in the first space adjusting member, and the second space adjusting member is constructed for resting against the other of the elements.

As an alternative, the two space adjusting members can each be screwed into one of the two elements. In this case, the free faces of the two space adjusting members abut one another.

Furthermore, the first space adjusting member and/or the second space adjusting member may be arranged coaxially with respect to the connection member, permitting moment-free transmission of the prestressing force between the two elements.

In another preferred embodiment, the connection member has a screwed bracing connection in order to brace the first element with respect to the second element. After the precision adjustment has been carried out via the first and second space adjusting members, the two elements are thereby braced with respect to one another in order to fix the result of the precision adjustment (specifically the space between the two elements).

Preferably, the first and/or the second element is or are constructed as a holder for an assigned structure. As a result, the system can be used in a flexible manner. In this case, the first element and/or the second element preferably has or have an inclination adjusting device for the assigned structure. The mounting flexibility of the system is thereby increased because it can be used not only for structures that extend parallel to one another, but is also suitable for structures disposed at an angle to one another.

It is particularly preferable for the inclination adjusting device to have a spherical construction, so that a ball joint is formed which permits an adjustment of the inclination in all directions.

The invention also relates to a connection device for mechanically connecting at least two structures, the respective structures being connected with an assigned element of a system according to the invention for precision adjustment.

Another object of the invention is to provide a structural arrangement consisting of two structures, between which one precision adjustment system according to the invention respectively is arranged, in at least two mutually spaced locations.

In this case, a structural arrangement consisting of two structures is particularly preferable, between which one precision adjustment system according to the invention is arranged in each of three mutually spaced locations. As a rule, these three mutually spaced locations form the corners of a plane or spherical triangle.

### BRIEF DESCRIPTION OF THE DRAWINGS

The single FIGURE of the drawing is a longitudinal sectional view of a connection device for the mechanical connection of at least two structures, which connection device has the precision adjustment system according to the invention.

### DETAILED DESCRIPTION OF THE PREFERRED EMBODIMENTS

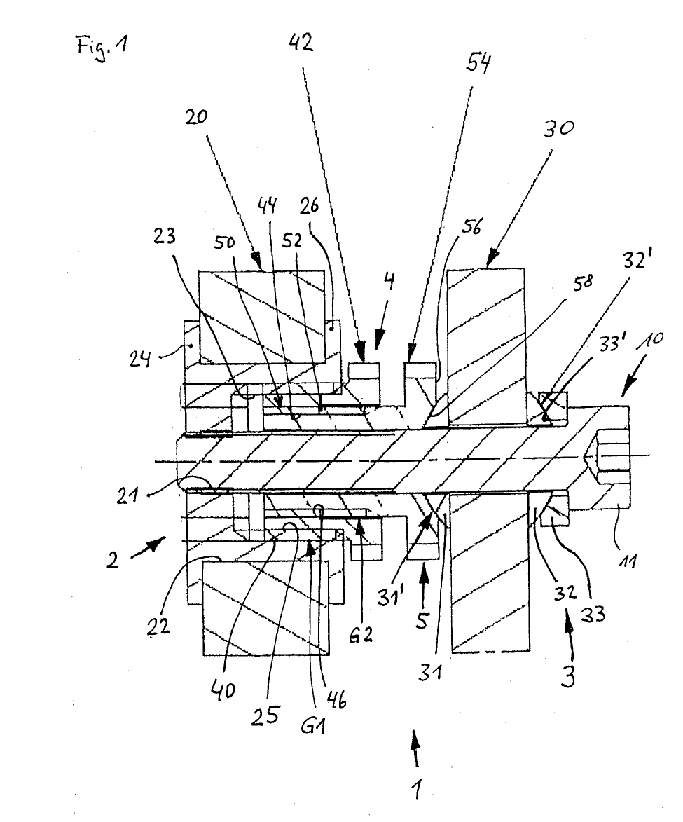

As shown in the FIGURE, the connection device 1 according to the invention includes a first element 2 which is constructed as a holder for a first structure 20. In the embodiment of FIG. 1, the first structure 20 comprises a plate having a borehole 22, through which the first element 2 extends. Two circular flanges 24, 26 of the first element 2 clamp the first plate-type structure 20 between one another.

The first element 2 is provided with a stepped through-hole 23, which has a first borehole section with a first, larger, diameter that is provided with a first thread 25 on its inner circumference. In addition, the through-hole 23 has a second borehole section with a smaller inside diameter, whose inner circumference has an internal threading 21 for a tightening screw 11.

On an outer circumference section, a first space adjusting member 4 is provided with a first counterthread 40 which engages in the first thread 25 of the first element 2 and, together with it, forms a first thread pairing G1 of a screwed connection. In addition, the first space adjusting member 4 has a section 42 with an enlarged outer circumferential surface that is constructed for the engagement of a tool, such as a wrench.

The first space adjusting member 4 is further provided with a central through-hole 44 in whose inner circumference a second counterthread 46 is constructed. A second thread 52 provided on an outer circumference section 50 of a second space adjusting member 5 is screwed into this second counterthread 46 and thereby forms a second thread pairing G2 of a screwed connection. The second space adjusting member 5 also has a section 54 with a larger outside diameter whose circumferential surface is also constructed for the engagement of a tool, such as a wrench.

A central concave indentation 58 provided on the free face 56 of the second space adjusting member bears against a first spherical-segment ring 31 with a one-side spherical surface 31′. The other (planar) surface of the first spherical-segment ring 31 bears against the second structure 30, which is also constructed as a plate.

On the other side of the second (plate-type) structure 30, an identically constructed second spherical-segment ring 32 is provided whose spherical surface 32′ bears again an adapted concave recess 33′ of a bearing ring 33.

The tightening screw 11 forming the connection member 10 extends centrally through the bearing ring 33, the second spherical-segment ring 32, the second structure 30, the first spherical-segment ring 31, the second space adjusting member 5 and the first space adjusting member 4 and is screwed into the internal thread 21 of the first element 2. In this manner, the tightening screw 11 can mutually brace the parts penetrated by it, of which parts the first spherical-segment ring 31, the second spherical-segment ring 32 and the bearing ring 33 form the second element 3.

The first thread pairing G1, consisting of the first thread 25 of the first space adjusting member 4 and of the first counterthread 40 in the first element 2 and has a first thread pitch α1. The second thread pairing G2 between the second thread 52 of the second space adjusting member 5 and the second counterthread 46 in the first space adjusting member 4 has a second thread pitch α2 which differs from the first thread pitch α1. In the illustrated example, the first thread pitch α1 is greater than the second thread pitch α2.

For example, the first thread pairing G1 is constructed as a thread M20 and the second thread pairing G2 is constructed as a thread M14. The larger thread M20 is provided between the first space adjusting member 4 and the first element 2, and the smaller thread M14 is provided between the first space adjusting member 4 and the second space adjusting member 5. The turn difference between these two different threads according to DIN 13 amounts to 0.5 mm. This corresponds to a typical fine-pitch thread. When the second space adjusting member 5 and the first element 2 are fixed and only the first space adjusting member 4 is rotated, the axial distance between the two elements 2, 3 will change by 0.5 mm per rotation of the first space adjusting member 4. A rotation by 5° therefore produces an axial adjustment of 7 μm.

If a thread pairing with a turn difference of 0.25 mm is selected as an alternative, a rotation by 5° causes an axial adjustment of 3.5 μm. The size of the space adjusting members 4, 5, particularly of their diameter, can basically be selected in an arbitrary manner, so that the selection of the corresponding threads and counterthreads can also be made arbitrarily.

When the desired adjustment has taken place (i.e., when the precision adjustment of the space between the two elements 2, 3 and thus between the two structures 20, 30 has taken place) the tightening screw 11 will be tightened, and the entire system for precisely adjusting the space will be fixed by the application of an axial tension. To prevent an unintended unscrewing of the tightening screw 11, the latter can be secured against torsion by means of conventional screw securing means, such as wire leading.

The connection arrangement according to the invention, shown in the Figure, therefore combines the high load bearing capacity of normal (standard) screw connections with the precise adjustability of fine-pitch threads.

The connection of two structures 20, 30 can also be achieved by means of three connection elements according to the invention. When exactly three such connection elements are situated at the apexes of an—imagined—plane or spherical triangle, the connection between the structures 20, 30 is statically defined and thus free of tensions. In this case, it is a prerequisite that, in each case, the structures are self-supporting, such as two base plates.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

Reference symbols in the claims, the description and the drawings are used only for better understanding the invention and should not limit the scope of protection.

### LIST OF REFERENCE SYMBOLS

1 Connection device
2 Element
3 Element
4 Space adjusting member
5 Space adjusting member
10 Connection member
11 Tightening screw
20 Plate-type structure
21 Tightening thread
22 Borehole
23 Through-hole
24 Circular jaw
25 Thread
26 Circular jaw
30 Structure
31 Spherical-segment ring
32 Spherical-segment ring
32′ Spherical surface
33 Bearing ring
33′ Concave recess
40 Counterthread
42 Section with an enlarged circumference
44 Through-hole
46 Counterthread
50 Outer circumference section
52 Thread
G1 Thread pairing
G2 Thread pairing
α1 Thread pitch
α2 Thread pitch

What is claimed is:

1. Apparatus for precisely adjusting the space between first and second elements, said apparatus comprising:
a connection member that mutually connects the first element and the second element;
a first space adjusting member; and
a second space adjusting member; wherein
the first space adjusting member has a first thread that interacts with an assigned counterthread of one of the elements;
the second space adjusting member has a second thread which interacts with an assigned counterthread of the first space adjusting member or of the other of the elements; and
the first thread and the second thread have different thread pitches.

2. The apparatus according to claim 1, wherein:
the counterthread assigned to the second thread of the second space adjusting member is provided on or in the first space adjusting member; and
the second space adjusting member is constructed to rest against the other of the elements.

3. The apparatus according to claim 1, wherein at least one of the first space adjusting member and the second space adjusting member is arranged coaxially with respect to the connection member.

4. The apparatus according to claim 1, wherein the connection member has a threaded bracing connection for bracing the first element with respect to the second element.

5. The apparatus according to claim 1, wherein at least one of the first element and the second element is constructed as a holder for an assigned structure.

6. The apparatus according to claim 5, wherein at least one of the first element and the second element has an inclination adjusting device for the assigned structure.

7. The apparatus according to claim 6, wherein the inclination adjusting device has a spherical construction.

8. Apparatus comprising two structures between which one system according to claim 1 is arranged in each of at least two mutually spaced locations.

9. The apparatus according to claim 8, wherein one system is arranged in at least two mutually spaced locations.

10. A coupling device for holding first and second structural elements at a precisely adjustable distance from each other, said coupling device comprising:
a first element for holding said first structural component;
a second element for holding said second structural element; and
first and second space adjusting members disposed between said first element and said second element; wherein,
a mutual spacing between said first element, said first space adjusting member and said second space adjusting member defines and fixes a mutual spacing between the first element and the second element;
said first element is coupled to said first space adjusting member by a first threaded coupling by which spacing between the first element and the first space adjusting member is adjustable;
said first space adjusting member is coupled to said second space adjusting member by a second threaded coupling by which spacing between said first and second space adjusting members is adjustable; and
said first and second threaded couplings have different thread pitches.

11. The coupling device according to claim 10, further comprising a threaded connection member for claming said second element to said first element.
